(19) United States
(12) Patent Application Publication
(10) Pub. No.: US 2013/0222137 A1
(43) Pub. Date: Aug. 29, 2013

(54) METHOD FOR ADAPTING A MOBILE COMMUNICATION DEVICE'S FUNCTION TO MONITORED ACTIVITY AND A USER'S PROFILE

(71) Applicants: Rachid M. Alameh, Crystal Lake, IL (US); William P. Alberth, Prairie Grove, IL (US)

(72) Inventors: Rachid M. Alameh, Crystal Lake, IL (US); William P. Alberth, Prairie Grove, IL (US)

(73) Assignee: Motorola Mobility, Inc., Libertyville, IL (US)

(21) Appl. No.: 13/408,142

(22) Filed: Feb. 29, 2012

(51) Int. Cl. G08B 23/00

(52) U.S. Cl. 340/573.1

(57) ABSTRACT

A method for adapting a mobile communication device's function corresponding to monitored activity and a user's profile that includes determining whether monitored sensors have exceeded a predetermined sensory threshold based on close association with the user's stored profile and the real-time activity of the user; providing an alerting threshold specific to the user where the predetermined sensory threshold has been exceeded; automatically and dynamically change at least one function of the mobile communication device based on the newly determined alerting threshold; and adjust the alerting threshold based on whether the predetermined sensory threshold has been exceeded.

### FIELD OF THE DISCLOSURE

The present disclosure relates generally to adaptive functions for a mobile communication device and more particularly to monitoring activity of a user and adapting one or more mobile communication device functions to the specific user.

### BACKGROUND

Conventionally, several mobile communication device behaviors are not necessarily optimized for a specific mobile communication device user. At least not without some manual intervention. For example, in many cases, sensory trigger thresholds are likely to be fixed, thereby not adjusting or changing to a user's needs at any given period. Notably, these sensory thresholds rarely accommodate for a user's physical limitations or medical history, for example. As such any wellness application may not be able to provide accurate and timely information to a specific mobile communication device user.

Accordingly, there is a need for a method for adapting a mobile communication device's function corresponding to monitored activity and a user's profile.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is an illustrative block diagram of a mobile communication device.

FIG. 2 is an example graphical representation illustrating dynamic sensory thresholds for one or more users.

FIG. 3 is another example graphical representation illustrating dynamic sensory thresholds for one or more users compared to a nominal suggested pattern.

FIG. 4 is another example graphical representation employing time segments for illustrating dynamic sensory thresholds for one or more users.

FIG. 5 is an exemplary example graphical representation illustrating dynamic sensory thresholds for multiple users compared to a nominal suggested pattern for a single timed workout session.

FIG. 6 is yet another example graphical representation illustrating a sensory threshold deviating from a nominal suggested pattern.

FIG. 7 is an exemplary flowchart according to one or more described embodiments.

FIG. 8 shows optional steps that may be incorporated in the flowchart of FIG. 7.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus, system, and steps or have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Allow monitored sensors to adaptively change, trigger points and warnings to a mobile communication device user by considering the user's needs, limitations, things to avoid, which can be included in a profile stored in a device's memory. Also, means are proposed to enhance the system to constantly update new learned thresholds into memory. The system uses current live or monitored sensors, stored history, and context to tailor different responses to different uses based on above. The outcome is a feedback from the device to the mobile communication device user that is specific to that mobile communication device user.

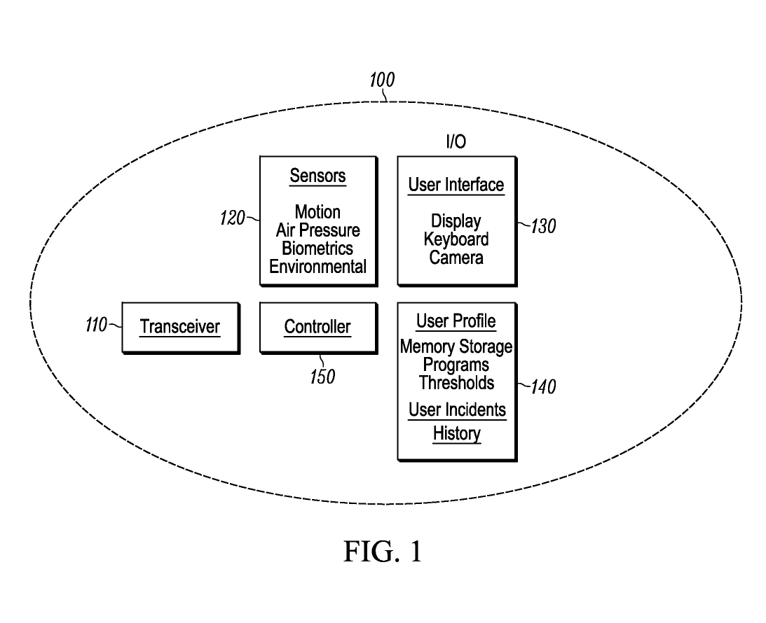

FIG. 1 is an illustrative block diagram of an exemplary mobile communication device 100. Mobile communication device 100 can be, for example, a smartphone, a computing tablet, a pager, a gaming device, or a wellness device that monitors exercise or health conditions. The exemplary mobile communication device 100 can include at least one transceiver 110 for transmitting and receiving wireless communication signals and data signals. Data signals may also be received by one or more sensors 120. Sensors 120 can monitor or receive vital signs or wellness data from a user of the mobile communication device 100. The sensors 120 can monitor or receive information that in some cases can be converted to detectable signals to indicate, for example, motion, air pressure, biometrics corresponding to mammal biology, and environmental conditions, including atmospheric, chemical, and magnetic resonance. A user of the mobile communication device 100 may interact or interface by employing one or more means of input/output 130. Input/output 130 can include a touchscreen user interface coupled to a display output, a keyboard, or a camera for capturing external visual conditions and content. Additionally, mobile communication device 100 can include a memory location 140 that stores user profiles, user incidents or occurrences, historical data, one or more operating programs, and one or more threshold levels and patterns. A user profile can include wellness conditions such as heart rate, blood pressure, respiratory rate, perspiration levels, muscle tremor data, gait, user preferences, and medical history, for example. The user profile may also include age, weight, gender, ethnicity, genetic data, caloric intake, meal preference, hormonal balance or factors, for example. A controller 150 is coupled to transceiver 110, sensors 120, I/O interface 130, and memory location 140 for controlling data flow, signal strength, and operational conditions, for example.

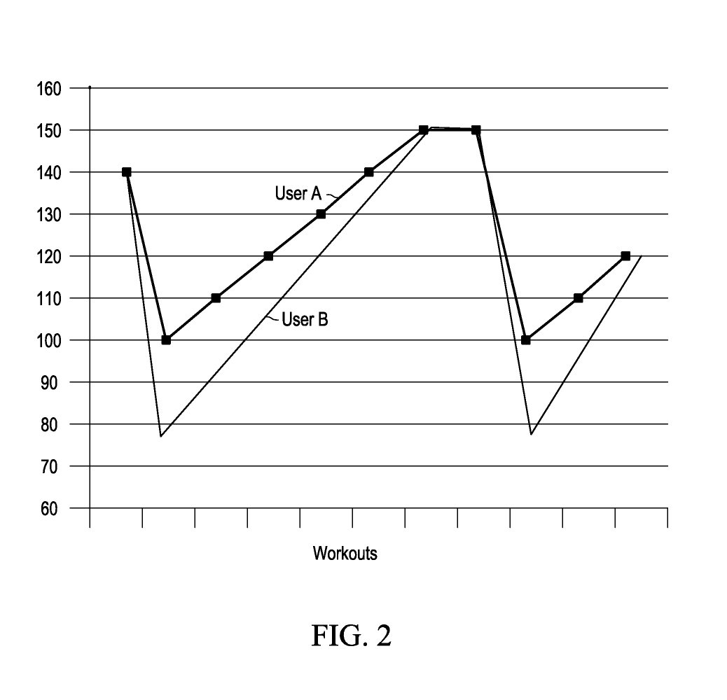

FIG. 2 is an example graphical representation illustrating dynamic sensory thresholds for one or more users. FIG. 2 shows x-y coordinate system, wherein the Y-axis includes threshold levels corresponding to sensory input data, and the X-axis includes incidents, events or occurrences. The incidents or occurrence can be for example exercise workout sessions, also referred to herein as exercise workout periods. The exercise workout sessions can be individual exercise workout sessions or extended over several time periods, for example, minutes, hours, days, months. The X-axis may also be graduated into time periods that can be seconds, minutes, hours, or fractions thereof, for example. FIG. 2 illustrates two users, user A and user B, but may illustrate only one user or several additional users as well. User A has a sensor threshold specific to user A that has incorporated user A's profile. Likewise, user B has a sensor threshold specific to user B that has incorporated user B's profile. A working example can be as follows:

User A has a user profile that includes exercise induced asthma. If user A's heart rate exceeds a specified or predetermined sensory threshold during exercise, then user A is warned to cool off. The sensory threshold numbers could be arbitrary numbers that are sensor specific. Where the sensory threshold is monitoring heart rate, the sensory threshold begins at 140 (representing a sensor measurement or threshold number) and user A has an heart-rate incident during workout, then the sensory threshold can be lowered to 100 (representing a sensor measurement or threshold number), for example, for user A's next exercise workout session. Given that user A exhibits no incidents or problems during his next session, the sensory threshold can be increased incrementally for each trouble-free session. The sensory threshold can have a maximum level, for example, 150. If at the maximum level, user A experiences another troublesome incident, the sensory threshold reverts back to user A's minimum level, for example, in this case at 100.

User B in FIG. 2 can be contrasted or compared to user A. User B may be more sensitive to incidents based on user B's user profile, thereby requiring different threshold management than user A. In FIG. 2, user B's minimum is 80 versus 100 for user A. Notably, the sensory threshold levels can be changed for current workout sessions or subsequent workout sessions.

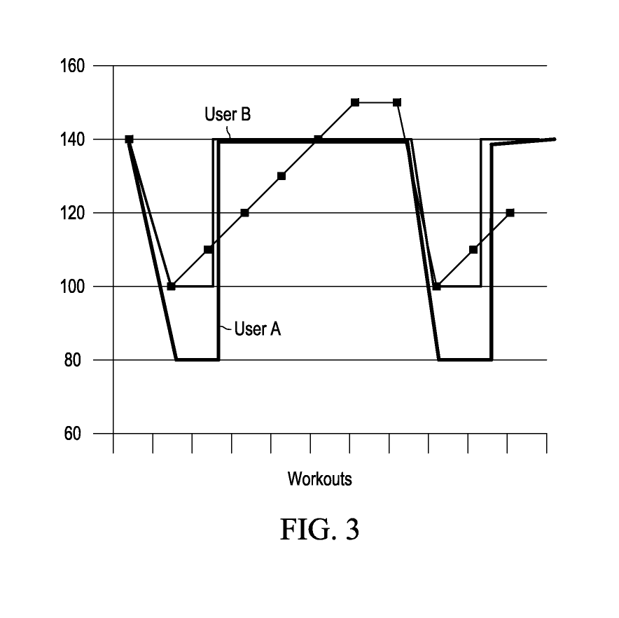

FIG. 3 is another example graphical representation illustrating dynamic sensory thresholds for one or more users compared to a nominal suggested pattern. Both users, user A and user B have contrasting or different sensory threshold patterns than a nominal suggested pattern. The nominal suggested pattern can be a model or paradigm for a certain age and gender group. In FIG. 3, user A has a lower minimum than user B; however, both users were able to maintain a sensory threshold of 140 for either several workout sessions or in the case of a single or individual workout session both users maintained the level at 140 for several minutes, for example. As illustrated, the thresholds are adjusted based on profiles when an incident is detected and the thresholds return to normal in the absence of any incident.

FIG. 3 also shows an example graphical representation illustrating dynamic sensory thresholds for multiple users compared to a nominal suggested pattern during multiple workout sessions. In the illustration user A and user B each have independent and distinct patterns different from the nominal suggested pattern. The multiple workout sessions are distinct from each other.

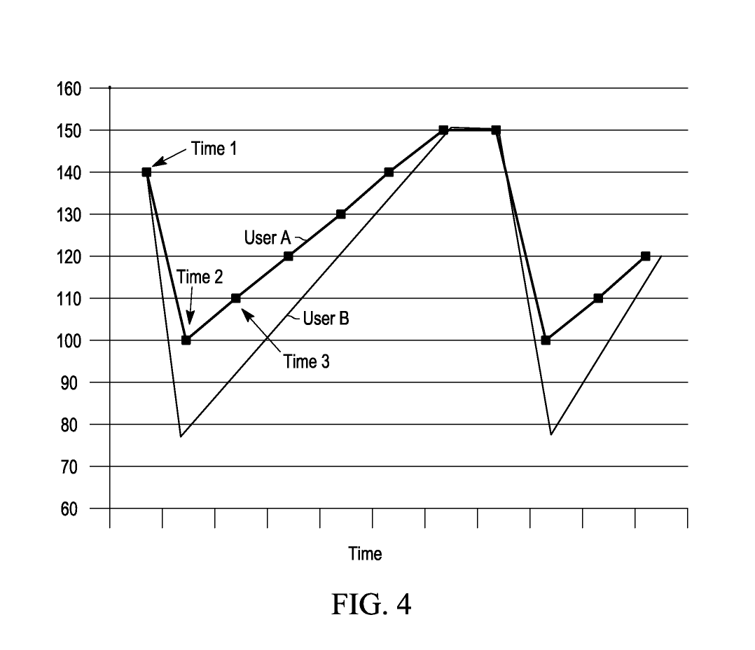

FIG. 4 shows an exemplary graphical representation employing time segments for illustrating dynamic sensory thresholds for one or more users. FIG. 4, the X-axis is in time segments or units that occur during a single workout session, for example. A time interval in which the sensory threshold is measured can be for example ten minutes, however, this time interval can be adjusted or vary according to each user. User “A” depicted in the graph can be a paradigm user or can represent past or future readings for user “B” to obtain. Alternatively, user A and user B readings can be independent and distinct from one another. FIG. 4 is similar to FIG. 2, except X-axis corresponds to time session within a workout session.

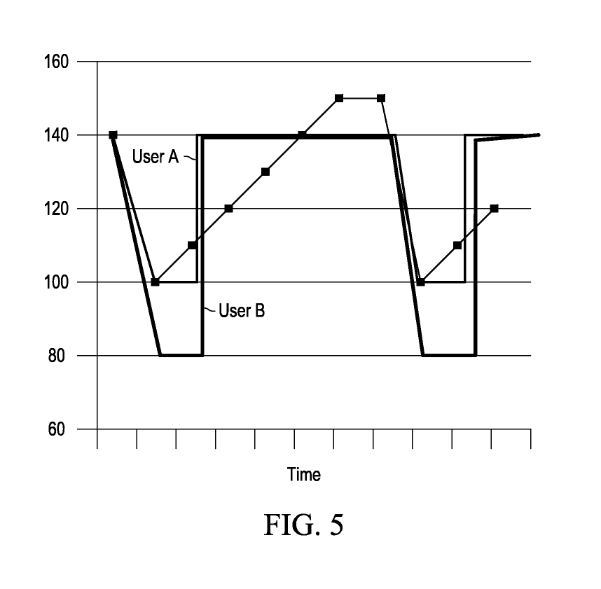

FIG. 5 is an exemplary example graphical representation illustrating dynamic sensory thresholds for multiple users compared to a nominal suggested pattern for a single timed workout session. The workout session can have alternative time intervals, for example, every five minutes a sensory threshold measurement may be taken, or every ten minutes. The time intervals can correspond to the user's needs or desires. FIG. 5 is similar to FIG. 3, except the X-axis or horizontal axis corresponds to a time window within an individual session.

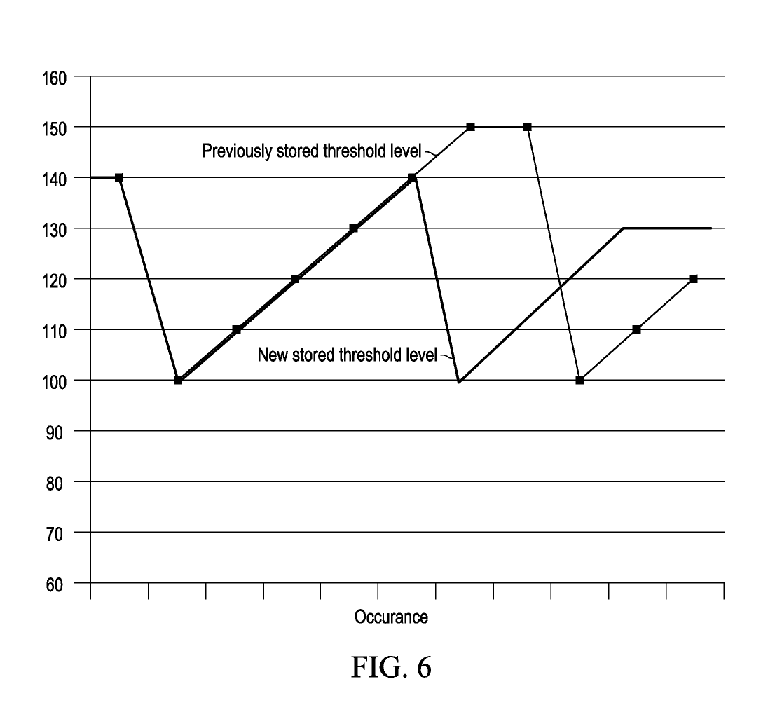

FIG. 6 is yet another example graphical representation illustrating a sensory threshold deviating from a nominal suggested pattern. The nominal suggested pattern, for the sensory threshold, can be a paradigm pattern or a former pattern for the user that may have been stored in memory. The new sensory threshold level and pattern can also be stored in memory for future use. A sensory threshold pattern can change in slope, amplitude, duration and at specific trigger points.

Alternatively, one pattern may be a previous pattern corresponding to a previous exercise workout session that will be compared to a new pattern from a more recent workout session. The new pattern illustrates that the threshold changed when an incident occurred and then returned to previous threshold when the incident was no longer perceived or sensed. Above schemes represent only a a small sample of patterns for interest, but many more patterns can be envisioned based on type of incident, user condition, user context, frequency of incidents, and user profile.

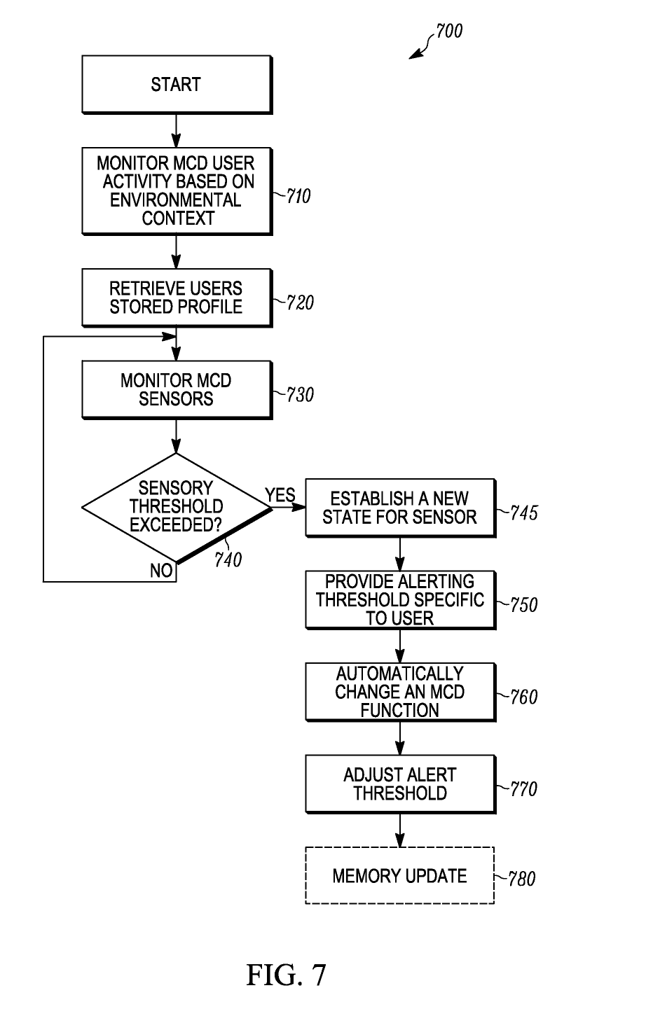

FIG. 7 is an exemplary flowchart 700 for adapting a mobile communication device's function corresponding to monitored activity and a user's profile. Several operational steps may be implemented. Step 710 monitors real-time activity of a mobile communication device user based on environmental context associated with the user. The environmental context can include location and physical status of the mobile communication device, i.e., stationary or moving.

Step 720 retrieves a user's stored profile. The user's profile can be stored internally in the mobile communication device or can reside on removable media or can reside on a server. Such a server is capable of having data transmitted to it.

Step 730 monitors one or more sensors communicatively coupled to the mobile communication device. The sensors can retrieve data associated with movement, location, device power, miniscule muscle tremors, and voice characteristics, for example. Accordingly, monitoring accelerometer data can be useful to the process or method.

Step 740 determines whether the monitored sensors have exceeded a predetermined sensory threshold based on a close association with the user's stored profile and the real-time activity of the user to establish a new state for at least one of the sensors. The new state of the sensor can comprise a new level or trigger for the sensor.

Step 750 provides an alerting threshold, specific to the user, based on the real-time activity, the user's stored profile, and the new state of at least one of the sensors where the predetermined sensory threshold has been exceeded. An alerting threshold can vary in its alignment with the specific user.

Step 760 automatically and dynamically changes at least one function of the mobile communication device based on an alerting threshold. One function of the mobile communication device that can be dynamically changed is the camera function, which can be activated or deactivated to cause capture of images, including both video and still images. Another function of the mobile communication device that can be dynamically changed is the global positioning system (GPS) circuitry that can be adjusted to either increase or decrease GPS location fixes and can cause or initiate a GPS update function. Specifically, one or more operations may include adjusting time between GPS location fixes or initiating a GPS update. Similarly, a dialing screen of the mobile communication device may be changed or affected based on the alerting threshold.

In the same vein, another function of the mobile communication device that can be dynamically changed can be enabling a microphone and a voice analyzer to accept voice inputs for further analysis. The analysis can include monitoring voice characteristics such as breathing patterns, speaking patterns, word usage, etc.

Another function of the mobile communication device that can be dynamically changed, based on the alerting threshold, can include causing transmission of data to a server at an increased rate above the normal data transmission rate of the mobile communication device.

Other functions of the mobile communication device that can be dynamically changed include recording audio, on/off power selection, uploading data to another party, notifications, disable selected sensors, adjust power crunching activities, select alternative device functions to save power, pairing with other wireless devices. This list of changeable functions is illustrative, but not exhaustive.

Step 770 adjusts the alerting threshold based on whether the predetermined sensory threshold has been exceeded. Additionally, the alerting threshold can be increased where the predetermined sensory threshold has not been exceeded and the changed function of the mobile communication device is terminated.

Upon adjusting the alerting threshold, the memory location, shown in FIG. 1, can optionally be updated to reflect new learned sensory threshold levels, frequency of occurrences, time of occurrences, user activity during occurrences, environmental contexts, and recent updates to the user profile.

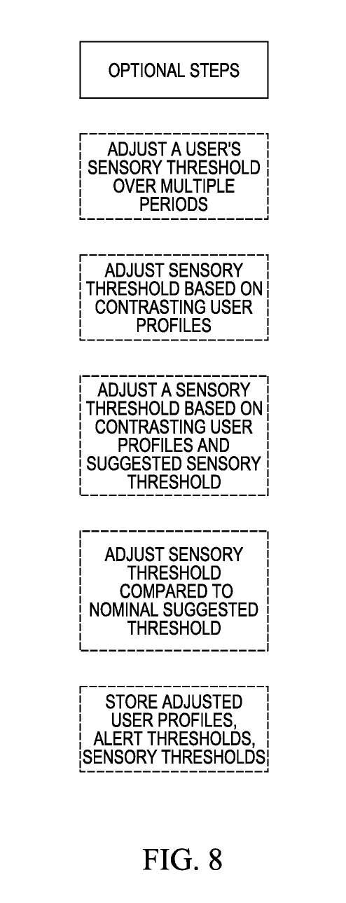

FIG. 8 illustrates several optional steps that can be implemented individually or as a group or pairing with the other steps shown in FIG. 7. The description of each of these exemplary additional optional steps follows.

Additional optional steps can include the step of adjusting a user's sensory threshold over several exercise workout periods.

Additional optional steps can include the step of adjusting a first user's sensory threshold different from a second user's sensory threshold over several exercise workout periods based on contrasting user profiles for a first user and a second user.

Additional optional steps can include the step of adjusting a first user's sensory threshold different from a second user's sensory threshold over several exercise workout periods based on contrasting user profiles for a first user and a second user, wherein the user sensory thresholds for the first user and the second user are both different than a nominal suggested sensory threshold.

Additional optional steps can include the step of dynamically adjusting the sensory threshold and pattern of monitoring different than a nominal suggested sensory threshold or pattern, thus resulting in a learned sensory threshold. Accordingly, the adjusted sensory threshold can be dynamically set at a level less than the nominal suggested threshold.

Additional optional steps can include the step of storing adjusted user profiles and adjusted or learned sensory thresholds and alert thresholds in the memory location.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, a method, an article, or an apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, a non-transitory machine readable storage device, having stored thereon a computer program that include a plurality of code sections for the implementation of the method, steps, or operations can be used in one or more embodiments. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Likewise, computer-readable storage medium can comprise a non-transitory machine readable storage device, having stored thereon a computer program that include a plurality of code sections for performing operations, steps or a set of instructions.

Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for adapting a mobile communication device's function corresponding to monitored activity and a user's stored profile, comprising:
a) monitoring real-time activity of a mobile communication device user based on environmental context associated with the mobile communication device user;
b) retrieving the user's stored profile;
c) monitoring sensors communicatively coupled to a mobile communication device;
d) determining whether monitored sensors have exceeded a predetermined sensory threshold based on close association with the user's stored profile and the real-time activity of the mobile communication device user to establish a new state for at least one of the sensors;
e) providing an alerting threshold, specific to the mobile communication device user, based on the real-time activity, the user's stored profile, and the new state of at least one of the sensors where the predetermined sensory threshold has been exceeded;
f) automatically and dynamically change at least one function of the mobile communication device based on the alerting threshold; and
g) adjusting the alerting threshold based on whether the predetermined sensory threshold has been exceeded.

2. The method according to claim 1, wherein the step of adjusting the alerting threshold further comprises increasing the alerting threshold where the predetermined sensory threshold has not been exceeded and a changed function of the mobile communication device is terminated.

3. The method according to claim 1, further comprising the step of updating a memory location with learned sensory thresholds corresponding to time parameters and historical occurrences.

4. The method according to claim 3, further comprising the step of adjusting a user's sensory threshold over a plurality of exercise workout periods.

5. The method according to claim 3, further comprising the step of adjusting a first user's sensory threshold different from a second user's sensory threshold over a plurality of exercise workout periods based on contrasting user profiles for a first user and a second user.

6. The method according to claim 3, further comprising the step of adjusting a first user's sensory threshold different from a second user's sensory threshold over a plurality of exercise workout periods based on contrasting user profiles for a first user and a second user, wherein user sensory thresholds corresponding to the first user and the second user are both different than a nominal suggested sensory threshold.

7. The method according to claim 3, wherein the step of updating the memory location comprises either individual exercise workout sessions or extends over a plurality of exercise workout periods.

8. The method according to claim 3, further comprising the step of dynamically adjusting a sensory threshold and pattern of monitoring different than a nominal suggested sensory threshold or pattern.

9. The method according to claim 8, wherein the sensory threshold is adjusted at a level less than the nominal suggested sensory threshold.

10. The method according to claim 1, wherein the step of automatically and dynamically changes the at least one function of the mobile communication device based on the alerting threshold further comprises activating a camera function.

11. The method according to claim 1, wherein the step of automatically and dynamically changes the at least one function of the mobile communication device based on the alerting threshold further comprises adjusting time between GPS location fixes or initiating a GPS update.

12. The method according to claim 1, wherein the step of automatically and dynamically changes the at least one function of the mobile communication device based on the alerting threshold further comprises monitoring accelerometer data for miniscule muscle tremors or shaking.

13. The method according to claim 1, wherein the step of automatically and dynamically changes the at least one function of the mobile communication device based on the alerting threshold further comprises monitoring voice characteristics changes via a microphone.

14. The method according to claim 1, wherein the step of automatically and dynamically changes the at least one function of the mobile communication device based on the alerting threshold further comprises transmitting data to a server at an increased rate.

15. The method according to claim 1, wherein the step of automatically and dynamically changes the at least one function of the mobile communication device based on the alerting threshold further comprises activating a dialing screen of the mobile communication device.

16. The method according to claim 1, wherein the step of automatically and dynamically changes the at least one function of the mobile communication device based on the alerting threshold further comprises changing a function selected from a group consisting of cameras, recording audio, updating GPS, on/off power selection, uploading data to another party, notifications, disable selected sensors, adjust power crunching activities, select alternative device functions to save power, pairing with other wireless devices.

17. The method according to claim 3, further comprising storing adjusted user profiles and adjusted sensory and alert thresholds in the memory location.

18. A system for adapting a mobile communication device's function corresponding to monitored activity and a user's stored profile, comprising,
means for monitoring a real-time activity of a mobile communication device user based on environmental context associated with the mobile communication device user;
means for retrieving the user's stored profile;
means for monitoring sensors communicatively coupled to a mobile communication device;
means for determining whether monitored sensors have exceeded a predetermined sensory threshold based on close association with the user's stored profile and the real-time activity of the mobile communication device user to establish a new state for at least one of the monitored sensors;
means for providing an alerting threshold, specific to the mobile communication device user, based on the real-time activity, the user's stored profile, and the new state of at least one of the monitored sensors where the predetermined sensory threshold has been exceeded;
means for automatically and dynamically changing at least one function of the mobile communication device based on the alerting threshold; and
means for adjusting the alerting threshold based on whether the predetermined sensory threshold has been exceeded.

19. A non-transitory machine readable storage device, having stored thereon a computer program that includes a plurality of code sections comprising:
code for monitoring real-time activity of a mobile communication device user based on environmental context associated with the mobile communication device user;
code for retrieving a user's stored profile;
code for monitoring sensors communicatively coupled to a mobile communication device;
code for determining whether monitored sensors have exceeded a predetermined sensory threshold based on close association with the user's stored profile and the real-time activity of the mobile communication device user to establish a new state for at least one of the sensors;
code for providing an alerting threshold specific to the mobile communication device user based on the real-time activity, the user's stored profile, and the new state of at least one of the sensors where the predetermined sensory threshold has been exceeded;
code for automatically and dynamically change at least one function of the mobile communication device based on the alerting threshold; and code for adjusting the alerting threshold based on whether the predetermined sensory threshold has been exceeded.
